(19) United States
(12) Patent Application Publication
(10) Pub. No.: US 2021/0357220 A1
(43) Pub. Date: Nov. 18, 2021

(54) EXECUTING INSTRUCTIONS

(71) Applicant: HEWLETT-PACKARD DEVELOPMENT COMPANY, L.P., Spring, TX (US)

(72) Inventors: Pierre Belgarric, Bristol (GB); Christopher l. Dalton, Bristol (GB); David Plaquin, Bristol (GB); Maugan Villatel, Bristol (GB); Joshua Serratelli Schiffman, Bristol (GB)

(21) Appl. No.: 16/606,762

(22) PCT Filed: Jul. 31, 2018
(86) PCT No.: PCT/US2018/044676

§ 371 Date: Oct. 20, 2019

(51) Int. Cl. G06F 9/30

(52) U.S. Cl. CPC G06F 9/30072

(57) ABSTRACT

Examples include an example computing system comprising a first storage to store executable code, wherein the executable code comprises a plurality of instructions, a second storage to store a first parameter of the executable code, a processing unit to execute each of the instructions of the code, and a monitoring component to, upon execution of each of the instructions of the code by the processing unit, update a second parameter of the code based on that instruction, wherein the monitoring component is to compare the first parameter and the second parameter, and to control execution of further executable code by the processing unit based on the comparison.

### BACKGROUND

In some computing systems, a secure boot process may be used whereby after power on or a reset, a processor first executes code held at a particular location, for example on a particular storage device and/or at a particular address. The code may be considered as trusted and secure, and hence the computing system may also be considered as trusted and secure.

### BRIEF DESCRIPTION OF DRAWINGS

Examples will now be described, by way of non-limiting example, with reference to the accompanying drawings, in which:

FIG. 1 is a simplified schematic of an example of a computing system;

FIG. 2 is a simplified schematic of an example of a computing system; and

FIG. 3 is a flow chart of an example of a method of executing instructions.

### DETAILED DESCRIPTION

Code to be executed in a secure boot process may reside in secure memory, such as for example a read-only memory (ROM), or a one-time programmable (OTP) memory on a data processor chip. Therefore, execution of the code may in some examples be considered to be secure or trusted. However, storing code on-chip or in ROM or OTP memory may increase cost of a processor chip or a system containing the chip or memory.

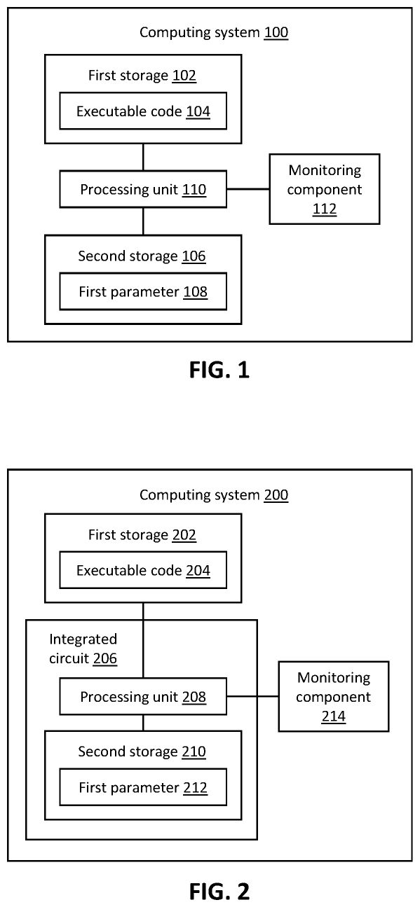

FIG. 1 is a simplified schematic of an example of a computing system 100. The computing system comprises a first storage 102 to store executable code 104. The executable code 104 comprises a plurality of instructions, for example instructions that are executable by a processing unit. The computing system 100 also includes a second storage 106 to store a first parameter 108 of the executable code. In some examples, the first parameter 108 may be a value related to the code, such as for example a hash or digest. In some examples, the first parameter 108 may be a value related to the expected behaviour of the code when executed by a processing unit.

The computing system 100 further comprises a processing unit 110 (e.g. a data processor, central processing unit, CPU, or multiple data processors or CPUs) to execute each of the instructions of the code 104. The computing system 100 also includes a monitoring component 112. The monitoring component 112 is to, upon execution of each of the instructions of the code 104 by the processing unit 110, update a second parameter of the code based on that instruction, wherein the monitoring component 112 is to compare the first parameter 108 and the second parameter, and to control execution of further executable code by the processing unit 110 based on the comparison.

In some examples, the monitoring unit 112 may update the second parameter upon execution of each instruction of the code 104, either just before or just after the instruction is executed. For example, the processing unit 110 may retrieve one of the instructions from the first storage 102, and either update the second parameter then execute the instruction, or execute the instruction then update the parameter. The second parameter may in some examples be updated in the same manner in which the first parameter 108 is created. For example, if the first parameter 108 is a hash value of the executable code 104, the same function that created the hash value can be used to update the second parameter, such that when a certain number of instructions have been used to update the second parameter (e.g. all of the instructions of the code 104), the second parameter can be compared to the first parameter 108 to verify or validate the executable code 104 (e.g. the first and second parameters are the same). In some examples, such as where the processing unit 110 includes a pipelined architecture that includes multiple processing stages, the monitoring unit 112 may update the second parameter during execution of each instruction of the code 104. For example, the monitoring unit 112 may update the second parameter either just before or just after the instruction is processed by a particular one of the processing stages.

In some examples, the predetermined number of instructions to be used to update the second parameter is also stored, for example within the second storage 106. Thus, for example, a comparison of the first and second parameters may be automatically performed after execution of the predetermined number of instructions and each associated update of the second parameter. In some examples, execution of instructions by the processing unit 110 may be limited or halted if a comparison instruction has not yet been encountered in the code 104 once the predetermined number of instructions has been executed. In other examples, a comparison may be automatically performed after a predetermined number of clock cycles of a component in the computing system 100 (e.g. the processing unit 110 or the monitoring component 112), or execution may be limited or halted if a comparison instruction has not yet been encountered after a predetermined number of clock cycles.

In some examples, the second parameter may be updated based on another property of the code 104, such as for example the behaviour of the code 104. For example, each instruction of the code 104 may perform certain functions such as for example altering a predetermined number of registers. A function used to update the second parameter may incorporate the behaviour of each instruction into the updated second parameter. Once a certain number (e.g. all) of the instructions of the code 104 have been executed and the second parameter updated accordingly, the second parameter can be compared to the first parameter 108 to verify or validate the executable code 104 (e.g. the first and second parameters are the same).

In some examples, for each instruction provided to the processing unit 110 for execution, the processing unit 100 may perform an associated microcode operation or multiple associated microcode operations. The second parameter may then be updated based on the microcode operations performed or to be performed for each instruction of the executable code 104.

In some examples, the monitoring unit 112 may generate the second parameter 112 before execution of any of or at least some of the executable code 104. For example, the second parameter may be generated using the same function used to create the first parameter. Then, the second parameter can be compared to the first parameter 108 to verify or validate the executable code 104 (e.g. the first and second parameters are the same). In some examples, the monitoring unit may place the second parameter 112 in another memory such as for example random access memory (RAM) from where it can be compared to the first parameter 108. In some examples, the first parameter 108 may also be loaded into RAM for the comparison.

In some examples, the monitoring component 112 is to compare the first parameter 108 and the second parameter in response to one of: a compare instruction in the executable code, and execution of a predetermined number of instructions of the plurality of instructions. Where for example the comparison is performed in response to a compare instruction, the first parameter 108 (and hence also the updated second parameter) may incorporate the compare instruction. In examples where the second parameter is updated upon execution (e.g. just before or just after execution) of each instruction of the code 104, the first and second parameters may in some examples incorporate the compare instruction if the second parameter is updated just before execution of the instruction.

In some examples, the monitoring component 112 is to control execution of further executable code by the processing unit based on the comparison by limiting functionality of the processing unit until a valid comparison of the first parameter and the second parameter. This may for example prevent unauthorized code (code that results in an invalid second parameter, e.g. one that does not match the first parameter 108) from performing unauthorized operations. In some examples, the functionality of the processing unit 110 may be limited until a valid comparison is made (e.g. in response to a compare instruction or after a certain condition is met, such as for example a compare instruction has automatically been executed a certain number of instructions have been executed), after which the functionality of the processing unit 110 may no longer be limited or restricted. In some examples, execution of instructions by the processing unit 110 after a certain number of instructions have been executed may be halted if a valid comparison has not been made. In some examples, execution of instructions by the processing unit 110 may be halted if the comparison is invalid, e.g. the first and second parameters do not match.

In some examples, the second storage 106 is internal to the processing unit 110. For example, the second storage 106 may reside on the same integrated circuit as the processing unit 110, on the same chip or within the same chip package. In some examples, the second storage 106 comprises one-time programmable (OTP) memory. In some examples, the monitoring component is internal to the processing unit 110. In some examples, the first storage 102 is external to the processing unit 110. For example, the first storage may comprise a read-only memory (ROM) or modifiable non-volatile memory (NVM). In some examples, the monitoring component 112 may be integrated with, be a part of or be a module of the processing unit 110.

In some examples, the computing system 100 is to compute the first parameter 108 based on the executable code 104 and store the first parameter 108 in the second storage 106. For example, the processing unit 110 or the monitoring component 112 computes the first parameter 108. In some examples, the first parameter 108 may be computed before any of the executable code 104 is executed, for example following power on or reset of the computing system 100. In some examples, the first parameter may be computed externally to the computing system 100 and stored in the second storage 106. In some examples, the first parameter 108 may be stored in the second storage 106 prior to power on or reset of the computing system 100. For example, the first parameter 108 may be stored upon manufacture or configuration of the computing system, upon manufacture of the first storage 102 and/or second storage 106, or upon an update of the executable code 104 by the computing system 100 (e.g. a firmware update).

In some examples, the executable code 104 may be loaded into random access memory, RAM (not shown) before it is accessed by the processing unit 110 and/or the monitoring component 112.

In some examples, a comparison of the first and second parameters may be performed both in hardware and in software. For example, in software, the executable code 104 may include a comparison instruction to perform the comparison. Additionally, the processing unit and/or monitoring component may include hardware (e.g. logic gates) to perform a comparison operation, for example when the software comparison instruction is encountered and/or following execution of a predetermined number of instructions. If the expected second parameter is different for each of the comparisons, two values for the first parameter may be stored, for example in the second storage, to provide an expected value for the hardware comparison and an expected value for the software comparison. In some examples, the software comparison may not take into account the comparison instruction, for example where the second parameter is updated after execution of each instruction, whereas the hardware comparison may take into account the comparison instruction.

FIG. 2 is a simplified schematic of an example of a computing system 200. The computing system comprises a first storage 202 to store executable code 204, wherein the executable code comprises a plurality of instructions. The computing system 200 further comprises an integrated circuit 206 comprising a processing unit 208 to execute each of the instructions of the code and a second storage 210 to store a first parameter 212 of the executable code. For example, the second storage 210 may be OTP memory storing the first parameter 212. In some examples, the first parameter may be pre-programmed into the second storage 210, or may alternatively be determined (e.g. computed by the processing unit or a monitoring component 214) following power on or reset of the computing system 200.

The computing system 200 also includes a monitoring component 214 to compute a second parameter of the code 204, to verify the code 204 by comparing the first parameter 212 and the second parameter (e.g. by determining that the parameters are the same), and to control execution of code (e.g. the code 204 and/or other code) by the processing unit 208 based on the comparison. For example, if the comparison indicates that the second parameter is invalid, and that the executable code 204 may be unauthorized code, the processing unit may have reduced functionality, or may be prevented from executing any code following the comparison. In some examples, additionally or alternatively, the functionality of the processing unit 208 may be reduced until a valid comparison is made. In some examples, the integrated circuit 206 comprises the monitoring component 214. In some examples, features and/or functions of the computing system 200 may be similar or identical to those of the computing system 100 described above with reference to FIG. 1.

In some examples, the monitoring component 214 is to compute the second parameter of the code 204 and to verify the code 204 by comparing the first parameter 212 and the second parameter before execution of the executable code 204 by the processing unit. In some examples, the code 204 may be loaded into RAM (not shown) before the second parameter is computed and before the code 204 is executed.

In some examples, the monitoring component 214 is to control execution of the code 204 by the processing unit 208 based on the comparison by limiting functionality of the processing unit until a valid comparison of the first parameter 212 and the second parameter.

In some examples, the first parameter comprises a hash or digest of the executable code and/or of an expected behaviour of the executable code (e.g. digest of the changes to the internal state of the processing unit made by the instructions of the executable code 104).

Some examples of processing units may provide a way to observe the flow of executed instructions. Therefore, in some examples, a discrete monitoring component (e.g. chip or integrated circuit) could probe the instructions executed by a processing unit following power on or reset, and check that their hash (e.g. hash of a predetermined number of executed instructions) matches a hash stored in, for example, an OTP storage of the discrete component. In another example, a processing unit may include, within the same chip, integrated circuit or system on a chip (SoC), a monitoring component block that monitors instructions executed by the processing unit. In both cases, the monitoring component may monitor executed instructions and prevent the processing unit from executing additional instructions if the hash is incorrect after a predetermined number of instructions have been executed, or in some examples if a hash compare or check instruction has not been executed within a predetermined number of executed instructions. In some examples, if the flow of instructions is not directly accessible externally to the processing unit, it may be possible for the monitoring component to deduce the flow of instructions through a side channel. For example, executed instructions may modify the state of a computing system. This state may in some examples be observed indirectly by a monitoring component by observing some information available externally to the processor (whether an analog or a digital signal, or multiple analog and/or digital signals).

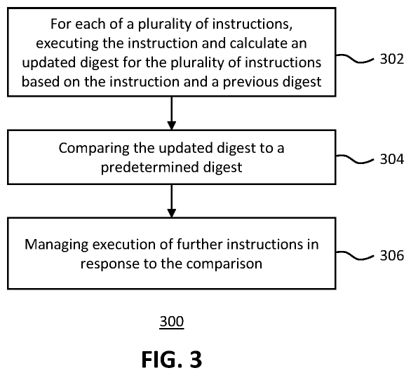

FIG. 3 is a flow chart of an example of a method 300 of executing instructions. The method 300 may be carried out by for example a computing system. The method 300 comprises, in block 302, for each of a plurality of instructions, execute the instruction and calculate an updated digest for the plurality of instructions based on the instruction and a previous digest. The digest may be updated based on for example the instruction (e.g. the value of data in memory indicating the instruction), or may be based on for example a behaviour of the instruction, for example based on how the instruction changes the internal state of a processing unit.

The method 300 also includes, in block 304, comparing the updated digest to a predetermined digest. In some examples, where the instructions are executed by a processing unit, the predetermined digest may be stored within the processing unit (e.g. in OTP memory).

The method 300 further comprises, in block 306, managing execution of further instructions in response to the comparison. In some examples, this may comprise preventing execution of further instructions in response to an invalid comparison. In some examples, additionally or alternatively, this may comprise restricting capabilities of the plurality of instructions and the further instructions until a valid comparison. For example, the functionality or capabilities of a processing unit may be reduced or restricted until a valid comparison is made. For example, the updated digest may be updated for a predetermined number of instructions or until a compare instruction comparing the first and second parameters is encountered. Then, for example, the updated digest may be compared to the predetermined digest, and if the comparison is valid (e.g. the digests are the same), then the capabilities or functionality of the processing unit may no longer be reduced, and/or the processing unit may be allowed to continue executing instructions.

In some examples, the method 300 comprises calculating the predetermined digest based on the plurality of instructions. The predetermined digest may be for example a hash value of the plurality of instructions. The predetermined digest may in some examples be calculated (and compared to the predetermined digest) before execution of at least some of the plurality of instructions is allowed. If the comparison is valid, execution of some or all of the plurality of instructions is allowed. In some examples, the method 300 may additionally or alternatively comprise calculating the predetermined digest based on changes to the state of the computing system (e.g. the state of a processing unit in the computing system).

Examples disclosed herein may, for example, securely store a small amount of data (e.g. hash value or digest) of code, instead of the code itself. Therefore, in some examples, secure or trusted storage may be reduced, while maintaining trust of the code (e.g. secure boot code) being executed. That is, for example, untrusted or modified code can be detected due to a digest value mismatch.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors or other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A computing system comprising:
a first storage to store executable code, wherein the executable code comprises a plurality of instructions;
a second storage to store a first parameter of the executable code;
a processing unit to execute each of the instructions of the code; and
a monitoring component to, upon execution of each of the instructions of the code by the processing unit, update a second parameter of the code based on that instruction, wherein the monitoring component is to compare the first parameter and the second parameter, and to control execution of further executable code by the processing unit based on the comparison.

2. The computing system of claim 1, wherein the monitoring component is to compare the first parameter and the second parameter in response to one of a compare instruction in the executable code and execution of a predetermined number of instructions of the plurality of instructions.

3. The computing system of claim 1, wherein the monitoring component is to control execution of further executable code by the processing unit based on the comparison by limiting functionality of the processing unit until a valid comparison of the first parameter and the second parameter.

4. The computing system of claim 1, wherein the first parameter comprises a hash or digest of the executable code or of an expected behaviour of the executable code.

5. The computing system of claim 1, wherein the second storage is internal to the processing unit.

6. The computing system of claim 5, wherein the first storage is external to the processing unit.

7. The computing system of claim 1, wherein the computing system is to compute the first parameter based on the executable code and store the first parameter in the second storage.

8. A computing system comprising:
a first storage to store executable code, wherein the executable code comprises a plurality of instructions;
an integrated circuit comprising a processing unit to execute each of the instructions of the code and a second storage to store a first parameter of the executable code; and
a monitoring component to compute a second parameter of the code, to verify the code by comparing the first parameter and the second parameter, and to control execution of the code by the processing unit based on the comparison.

9. The computing system of claim 8, wherein the integrated circuit comprises the monitoring component.

10. The computing system of claim 8, wherein the monitoring component is to compute the second parameter of the code and to verify the code by comparing the first parameter and the second parameter before execution of the executable code by the processing unit.

11. The computing system of claim 8, wherein the monitoring component is to control execution of the code by the processing unit based on the comparison by limiting functionality of the processing unit until a valid comparison of the first parameter and the second parameter.

12. The computing system of claim 8, wherein the first parameter comprises a hash or digest of the executable code or of an expected behaviour of the executable code

13. A method of executing instructions, the method comprising:
for each of a plurality of instructions, executing the instruction and calculate an updated digest for the plurality of instructions based on the instruction and a previous digest;
comparing the updated digest to a predetermined digest; and
managing execution of further instructions in response to the comparison.

14. The method of claim 13, wherein managing execution of further instructions in response to the comparison comprises one of:
preventing execution of further instructions in response to an invalid comparison; and
restricting capabilities of the plurality of instructions and the further instructions until a valid comparison.

15. The method of claim 13, comprising calculating the predetermined digest based on the plurality of instructions.
